(19) United States
(12) Patent Application Publication
(10) Pub. No.: US 2022/0414586 A1
(43) Pub. Date: Dec. 29, 2022

(54) Pick & Pack Order fulfillment barcode Scan Check Program

(71) Applicant: Michael Alan Jelliff, Tyler, TX (US)

(72) Inventor: Michael Alan Jelliff, Tyler, TX (US)

(21) Appl. No.: 17/356,532

(22) Filed: Jun. 24, 2021

(51) Int. Cl. G06Q 10/08; G06Q 10/06

(52) U.S. Cl. CPC G06Q 10/087; G06Q 10/063114; G06Q 10/083

(57) ABSTRACT

A system facilitating the order processing till delivery system ensuring that correct products are added in the final order and required timelines are met. The proposed system ensures that the shipper sends correct product, right quantity to maintain customer satisfaction in a cloud computing environment.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

Embodiments of the present disclosure are generally directed to electronic commerce, and, more specifically, to methods and systems for facilitating automated online purchase, order routing and delivery of products/goods and services through communication between customers and retail associates, within an application-based environment.

### Description of the Related Art

A warehouse is a facility in the supply chain to consolidate products to reduce transportation cost, achieve economies of scale in manufacturing or in purchasing or provide value—added processes and shorten response time. Warehousing has also been recognized as one of the main operations where companies can provide tailored services for their customers and gain competitive advantage. There are various types of warehouses: they can be classified into production warehouses and distribution centers and by their roles in the supply chain they can be classified as raw materials warehouses, work-in-process warehouses, finished good warehouses, distribution warehouses, fulfillment warehouses, local warehouses direct to customer demand, and value-added service warehouses.

Handling goods of all types which are manufactured, packaged, and finally shipped to the vendor or buyer particularly in the age of online shopping via, the internet requires smart warehouse management comprising in particular transferring to stock, removing from stock, and transporting.

The situation becomes even more difficult when the goods are individually stocked and destocked in their own packaging. When various goods having different types of packaging and/or sizes of packaging are present, the situation becomes even more complicated. Automated and mechanized stocking and destocking in this case is very hard to implement so that stocking and destocking typically is performed manually.

Warehouses have been going through various challenges such as—supply chains are becoming more integrated and shorter, globalized operation, customers are more demanding and technology changes are occurring rapidly. In order to cope up with these challenges organizations are adopting innovative approaches such as warehouse management system.

A warehouse management system or WMS primarily aims to control the movement and storage of materials within a warehouse and process the associated transactions, including shipping, receiving, put-away and picking. A warehouse management system (WMS) is a database driven computer application, to improve the efficiency of the warehouse by directing cutaways and to maintain accurate inventory by recording warehouse transactions.

There are multiple solutions that have been presented in prior art. However, these solutions are limited and restricted to their conventional architecture, installation system and have considerable shortcomings which adversely affect the convenience with which they can be used. The prior systems have certain limitations including the design of assemblies which make them not suitable for every type of user. Moreover, the ease-of-use ability of these assemblies is also questionable.

It has to be noted that the current invention proposes a system which claims to overcome the current challenges related to order placement, routing and fulfillment within the e-commerce domain, particularly to improve customers' overall experience during the process of online shopping.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims and abstract as a whole.

The primary desirable object of the present invention is to provide a novel and improved form of an efficient method and a system for facilitating customers' order from order placement till delivery, in a cloud-based or web-based environment.

Another object of this invention is to provide a new and improved system where every item in order is scanned and packed to reduce the chances of error.

It is an object of the invention to provide set of AI based commands which use order and shipping label information to confirm the order fulfillment and associate/worker has correctly picked and is shipping the correct SKU's.

It is also the objective of the invention to provide an interface allowing multiple users to logged in and work independently or on same order.

Yet another object of the present invention is to provide a software which is easy to use and can work on all type of computing environments.

It is a further aspect of the present invention to provide a new and improved set of algorithms which are reliable and provide effective output under various circumstances.

Thus, it is the objective to provide a new and improved order fulfilment process. Other aspects, advantages and novel features of the present invention will become apparent from the detailed description of the invention when considered in conjunction with the accompanying claims.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Most known conventional customer order fulfillment processes generally include complex internal distribution systems, warehouse processes, procurement processes, customer order placement processes and may or may not include the capability of forecasting inventory levels. Most of these processes are done manually in that they are at least partially done with the use of considerable human intervention, which is inefficient, costly and time consuming. Some of these processes may take several days from the receipt of a customer order to the time of shipping.

There are multiple computers implemented systems that attempt to reduce the use of human intervention at various steps of such complicated manual fulfillment processes. However, they have not been completely successful because their architecture and methodology are deficient, and require manual intervention at some point during the process. For example, some known computer implemented systems that are currently in use in processing orders in large volume require human intervention in initially accepting the order and placing it in the system. However, human intervention is also needed to place a purchase order with a supplier to fulfill the customer order. Additionally, human intervention may be required to receive the ordered product from the supplier, place it in a warehouse, and then ship it to the customer. At every point in the process where human intervention is required, additional inefficiency, expense and time delay are introduced.

The system as per its additional embodiments allows the program to download to excel csv file the list of packages completed or pending for the day. The download file shows which user scanned the package or completed that order, and the time that user took to complete the package by using a time stamp.

The system as per its additional embodiments provides time stamp, which is created by a start time and end time which will calculate in minutes and seconds how long it took the package to complete each package. The start time is created by when the user scanned the last barcode of the previous package. The end time is created when the user scans the last barcode for the current package.

The system as per its additional embodiments allows the download file to displays the time, day and date of the time the packager completed the order. This allows to quickly review our security cameras in our warehouse to the specific time of day and date to review any specific package.

The system as per its additional embodiments allows the program to automatically save the end of day report to server every day.

The system as per its additional embodiments allows the user to press the “pause” button to stop the time. This is useful if they need to temporary pause their work process for a phone call or lunch break or any other similar event.

The system as per its additional embodiments, allows the user to put an order into “pending” status by pressing the button “Put in pending”. This is useful if the shipper cannot fulfill the order due to being out of stock. By putting into pending, the order will remain in the program for the next day for the shipper to keep in pending or fulfill the order.

The system as per its additional embodiments, allows the user to check the pending orders or update the pending orders to the days shipment by clicking the button “View pending items”.

The system as per its additional embodiments, allows the user to put the item into pending. The user can also mark the reason why the order is going into pending, which instructs the user to send an email to the customer service rep on what to do. For example, call the customer and let them know their item is out of stock and ask if they want a substitute or refund. Furthermore, the user can indicate the item which will be restocked within 2 weeks and will update the order will be fulfilled within 2 weeks when restocked.

The system as per its additional embodiments allows the user to toggle from next package in the list to previous package completed freely.

The system as per its additional embodiments displays how many packages are completed by all users and how many packages are left to be completed for the day.

The system as per its additional embodiments allows for a new data file to be combined with the current uploaded data file. For example, if the user did not complete yesterday's orders, and now has a new set of orders for the current day. The user will checkmark a box that reads “combine upload to previous day”. If checked then the new orders will be added to the unfinished orders which will combine all orders.

The system as per its additional embodiments, if the user is behind schedule, the program will notify the user “you are behind schedule” and the Percentage complete circle will turn red. If the user is on time it will display “You are on schedule” and the percentage complete circle will turn Green.

The system as per its preferred embodiments is an improved method and system for use by large scale multinational companies as well as small enterprises, wherein the advantages of the system include: substantially reducing the number of people that are required for processing customer orders through delivery of a product and billing for the same, substantially increasing the speed of processing of such customer orders through delivery and billing for the same, substantially reducing the overhead costs associated with such processing and reducing or eliminating the chances of error in order cycle. The system is extremely powerful in that it can operate on a worldwide basis and can accommodate literally thousands of products ordered by thousands of customers supplied by thousands of suppliers.

The system can run on Java program. It is downloaded to desktop software, and the data is stored and processed over the cloud. The user as per its preferred embodiments uploads the shipment data with the database to the program by CSV excel file to get all the datapoints. Then to get started, the user scans the barcode on the shipping label. This will bring up the matching order information for that shipping label, which will list all the SKU's and quantities to be picked and packed. On this screen also shows images of the product when fully assembled, where it is located in the warehouse, what box to use to ship, how long it should take to complete the packaging, any critical notes for this specific sku, what if anything to include with the package like special parts or inserts, a clickable link to click and an instructional video will play showing how to package that SKU, and the screen also shows the users current time and speed so that users know if they are running behind schedule or are currently on time to finish on time.

The user as per its further embodiments scan all the SKU barcodes for that shipping label. Once he has scanned all the SKU barcodes for that shipping label, then it will check mark off that shipping label as being complete. After this the user proceeds by scanning the next shipping label, and so on.

The user can repeat the same process until all packages are complete, and then once done everything will show as completed. It is also possible for multiple users to be logged in and work independently of one another on the same CSV upload file, so that multiple users can work on the same list but different packages.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A order fulfilment system comprising:
Interface to ensure that the correct product and quantity is packed within the desired timeline;
the order fulfilment system as per claim 1, allows the user to upload the data in excel file;
the order fulfilment system as per claim 1, the user to scan the barcodes on shipping label;
the order fulfilment system as per claim 1, presents the matching order information against the shipping label;
the order fulfilment system as per claim 1, where various information including but not limited to images of the product when fully assembled, location in the warehouse, box size for shipment, timeline in order delivery, critical notes for specific sku, things to include with the package like special parts or inserts, a clickable link to click and an instructional video showing how to package that SKU, and the screen showing the users current time and speed so that they know if they are running behind schedule or are currently on time to finish on time;
the order fulfilment system as per claim 1, where user can scan all SKU barcodes against shipping labels; and
the order fulfilment system as per claim 1, where once all barcodes are scanned, the shipping label can be marked as closed.
